(19) United States
(12) Patent Application Publication
(10) Pub. No.: US 2023/0172271 A1
(43) Pub. Date: Jun. 8, 2023

(54) HEATER FOR AEROSOL GENERATION DEVICES AND AEROSOL GENERATION DEVICE INCLUDING THE SAME

(71) Applicant: KT&G CORPORATION, Daejeon (KR)

(72) Inventors: Jong Seong JEONG, Daejeon (KR); Gyoung Min GO, Daejeon (KR); Hyung Jin BAE, Daejeon (KR); Jang Won SEO, Daejeon (KR); Chul Ho JANG, Daejeon (KR); Min Seok JEONG, Daejeon (KR); Jin Chul JUNG, Daejeon (KR)

(73) Assignee: KT&G CORPORATION, Daejeon (KR)

(21) Appl. No.: 17/923,789

(22) PCT Filed: Nov. 12, 2021
(86) PCT No.: PCT/KR2021/016504

§ 371 Date: Nov. 7, 2022

(30) Foreign Application Priority Data
Mar. 29, 2021 (KR) 10-2021-0040345

(51) Int. Cl. A24F 40/46; A24F 40/20

(52) U.S. Cl. CPC A24F 40/46; A24F 40/20

(57) ABSTRACT

A heater for aerosol generation devices and an aerosol generation device including the same are provided. The heater according to some embodiments of the present disclosure may include a first electroconductive pattern which is configured to perform a heating function and a second electroconductive pattern which is made of a material with a temperature coefficient of resistance higher than that of the first electroconductive pattern and is configured to perform a temperature measurement function for the heater. In this case, since a temperature of a heating surface of the heater may be accurately measured through the second electroconductive pattern, control precision for the heater may be improved.

### TECHNICAL FIELD

The present disclosure relates to a heater for aerosol generation devices and an aerosol generation device including the same, and more particularly, to a heater for aerosol generation devices which is capable of reducing a measurement error of a heating temperature and improving control precision and an aerosol generation device including the same.

### BACKGROUND ART

In recent years, demand for alternative smoking articles that overcome disadvantages of traditional cigarettes has increased. For example, demand for devices that electrically heat cigarettes to generate an aerosol (e.g., cigarette-type electronic cigarettes) has increased, and accordingly, active research has been carried out on electric heating-type aerosol generation devices.

Recently, a device that generates an aerosol by heating a cigarette from the outside with a heater in the form of a thin film having an electroconductive pattern formed thereon has been proposed. Like other aerosol generation devices, the proposed device controls the temperature of the heater through a separate temperature sensor attached in the vicinity of the heater.

However, when the temperature of the heater is measured using a separate temperature sensor, a measurement error inevitably occurs according to an attachment position or attachment state of the temperature sensor. Further, the measurement error may decrease precision of heater control and thus adversely affect a user’s smoking experience (e.g., decrease the taste of tobacco, decrease vapor production, etc.).

### DISCLOSURE

### Technical Problem

Some embodiments of the present disclosure are directed to providing a heater for aerosol generation devices which is capable of improving control precision through reduction of a temperature measurement error and an aerosol generation device including the same.

Some embodiments of the present disclosure are also directed to providing a heater for aerosol generation devices which is capable of guaranteeing uniform heat distribution and an aerosol generation device including the same.

Some embodiments of the present disclosure are also directed to providing a heater for aerosol generation devices which is capable of guaranteeing a high-speed temperature rise and an aerosol generation device including the same.

Some embodiments of the present disclosure are also directed to providing a control method of a heater for aerosol generation devices which includes a plurality of electroconductive patterns.

Objectives of the present disclosure are not limited to the above-mentioned objective, and other unmentioned objectives should be clearly understood by those of ordinary skill in the art to which the present disclosure pertains from the description below.

### Technical Solution

Some embodiments of the present disclosure provide a heater including a first electroconductive pattern which is configured to perform a heating function and a second electroconductive pattern which is made of a material with a temperature coefficient of resistance higher than that of the first electroconductive pattern and is configured to perform a temperature measurement function for the heater.

In some embodiments, the first electroconductive pattern and the second electroconductive pattern may be disposed on the same layer.

In some embodiments, the first electroconductive pattern and the second electroconductive pattern may be disposed on different layers.

In some embodiments, a resistance value of the second electroconductive pattern may be higher than that of the first electroconductive pattern.

In some embodiments, power supplied to the second electroconductive pattern may be smaller than power supplied to the first electroconductive pattern.

In some embodiments, the second electroconductive pattern may be disposed to measure a temperature of a central region of a heating surface on which the first electroconductive pattern is disposed, and a distance from a center of the heating surface to an edge of the central region may be 0.15 to 0.5 times a distance from the center to an edge of the heating surface.

In some embodiments, the heater may further include a third electroconductive pattern which is disposed in a parallel structure with the first electroconductive pattern and configured to perform the heating function, and the first electroconductive pattern may be made of a material whose temperature coefficient of resistance is 1,000 ppm/°C or lower.

In some embodiments, the first electroconductive pattern may be made of at least one material of constantan, manganin, and nickel silver.

### Advantageous Effects

According to some embodiments of the present disclosure, a heater in which a first electroconductive pattern (“heating pattern”) configured to perform a heating function and a second electroconductive pattern (“sensor pattern”) configured to perform a temperature measurement function are integrated can be manufactured. In this case, since a temperature of a heating surface on which the heating pattern is disposed can be measured directly through the sensor pattern, a temperature measurement error of the heater can be minimized. Also, accordingly, control precision for the heater can be improved, and thus an improved smoking experience can be provided to a user. Further, since there is no need to perform a process of assembling (i.e., attaching) a separate temperature sensor at the time of manufacturing an aerosol generation device, a process of manufacturing the aerosol generation device can also be simplified.

Also, an electroconductive pattern made of a material with a low temperature coefficient of resistance can serve as a heating pattern. In this case, since a high-speed temperature rise is guaranteed, a preheating time of the aerosol generation device can be decreased, and a tobacco smoke taste at the beginning of smoking can be significantly enhanced.

In addition, a plurality of electroconductive patterns can be disposed in a parallel structure, and a resistance value of an outer pattern can be designed to not be higher than a resistance value of a central pattern. Accordingly, heat can be uniformly generated throughout the entire heating surface of the heater, and thus the heating efficiency of the aerosol generation device can be improved.

The advantageous effects according to the technical spirit of the present disclosure are not limited to those mentioned above, and other unmentioned advantageous effects should be clearly understood by those of ordinary skill in the art from the description below.

### DESCRIPTION OF DRAWINGS

FIG. 1 is an exemplary view conceptually illustrating a film-type heater according to some embodiments of the present disclosure.

FIGS. 2 to 4 are exemplary views for describing the film-type heater according to some embodiments of the present disclosure.

FIG. 5 is a view for describing a layered structure of the film-type heater according to some embodiments of the present disclosure.

FIG. 6 is a view for describing a layered structure of the film-type heater according to some other embodiments of the present disclosure.

FIGS. 7 and 8 are exemplary views for describing a heating pattern structure of a film-type heater according to a first embodiment of the present disclosure.

FIGS. 9 and 10 are exemplary views for describing a heating pattern structure of a film-type heater according to a second embodiment of the present disclosure.

FIGS. 11 to 13 are exemplary block diagrams illustrating various types of aerosol generation devices to which the film-type heater according to some embodiments of the present disclosure may be applied.

FIG. 14 is an exemplary flowchart illustrating a control method of a film-type heater manufactured for use in an aerosol generation device according to some embodiments of the present disclosure.

FIG. 15 illustrates comparative experimental results relating to temperature rise speeds of film-type heaters according to an example and a comparative example.

FIG. 16 illustrates a pattern structure of a film-type heater according to examples.

FIGS. 17 and 18 illustrate comparative experimental results relating to heat distribution of film-type heaters according to examples.

### MODES OF THE INVENTION

Hereinafter, exemplary embodiments of the present disclosure will be described in detail with reference to the accompanying drawings. Advantages and features of the present disclosure and methods of achieving the same should become clear from embodiments described in detail below with reference to the accompanying drawings. However, the technical spirit of the present disclosure is not limited to the embodiments disclosed below and may be implemented in various different forms. The following embodiments only make the technical spirit of the present disclosure complete and are provided to completely inform those of ordinary skill in the art to which the present disclosure pertains of the scope of the disclosure. The technical spirit of the present disclosure is defined only by the scope of the claims.

In assigning reference numerals to components of each drawing, it should be noted that the same reference numerals are assigned to the same components where possible even when the components are illustrated in different drawings. Also, in describing the present disclosure, when detailed description of a known related configuration or function is deemed as having the possibility of obscuring the gist of the present disclosure, the detailed description thereof will be omitted.

Unless otherwise defined, all terms including technical or scientific terms used in this specification have the same meaning as commonly understood by those of ordinary skill in the art to which the present disclosure pertains. Terms defined in commonly used dictionaries should not be construed in an idealized or overly formal sense unless expressly so defined herein. Terms used in this specification are for describing the embodiments and are not intended to limit the present disclosure. In this specification, a singular expression includes a plural expression unless the context clearly indicates otherwise.

Also, in describing components of the present disclosure, terms such as first, second, A, B, (a), and (b) may be used. Such terms are only used for distinguishing one component from another component, and the essence, order, sequence, or the like of the corresponding component is not limited by the terms. In a case in which a certain component is described as being “connected,” “coupled,” or “linked” to another component, it should be understood that, although the component may be directly connected or linked to the other component, still another component may also be “connected,” “coupled,” or “linked” between the two components.

The terms “comprises” and/or “comprising” used herein do not preclude the possibility of presence or addition of one or more components, steps, operations, and/or devices other than those mentioned.

Prior to the description of various embodiments of the present disclosure, some terms used in the following embodiments will be clarified.

In the following embodiments, “aerosol-forming substrate” may refer to a material that is able to form an aerosol. The aerosol may include a volatile compound. The aerosol-forming substrate may be a solid or liquid.

For example, solid aerosol-forming substrates may include solid materials based on tobacco raw materials such as reconstituted tobacco leaves, shredded tobacco, and reconstituted tobacco, and liquid aerosol-forming substrates may include liquid compositions based on nicotine, tobacco extracts, and/or various flavoring agents. However, the scope of the present disclosure is not limited to the above-listed examples.

As a more specific example, a liquid aerosol-forming substrate may include at least one of propylene glycol (PG) and glycerin (GLY) and may further include at least one of ethylene glycol, dipropylene glycol, diethylene glycol, triethylene glycol, tetraethylene glycol, and oleyl alcohol. As another example, the aerosol-forming substrate may further include at least one of nicotine, moisture, and a flavoring material. As still another example, the aerosol-forming substrate may further include various additives such as cinnamon and capsaicin. The aerosol-forming substrate may not only include a liquid material with high fluidity but also include a material in the form of a gel or a solid. In this way, as the components constituting the aerosol-forming substrate, various materials may be selected according to embodiments, and composition ratios thereof may also vary according to embodiments. In this specification, “liquid” may refer to a liquid aerosol-forming substrate.

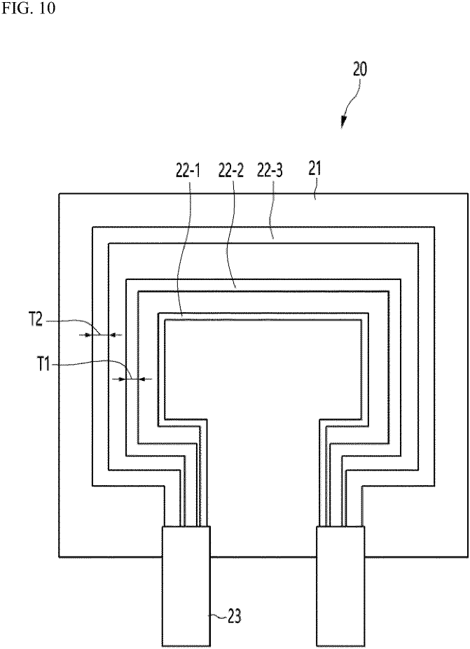

In the following embodiments, “aerosol generation device” may refer to a device that generates an aerosol using an aerosol-forming substrate in order to generate an aerosol that can be inhaled directly into the user’s lungs through the user’s mouth. Some examples of the aerosol generation device will be described below with reference to FIGS. 11 to 13.

In the following embodiments, “aerosol-generating article” may refer to an article that is able to generate an aerosol. The aerosol-generating article may include an aerosol-forming substrate. A typical example of the aerosol-generating article may include a cigarette, but the scope of the present disclosure is not limited thereto.

In the following embodiments, “puff” refers to inhalation by a user, and the inhalation may be a situation in which a user draws smoke into his or her oral cavity, nasal cavity, or lungs through the mouth or nose.

Hereinafter, various embodiments of the present disclosure will be described.

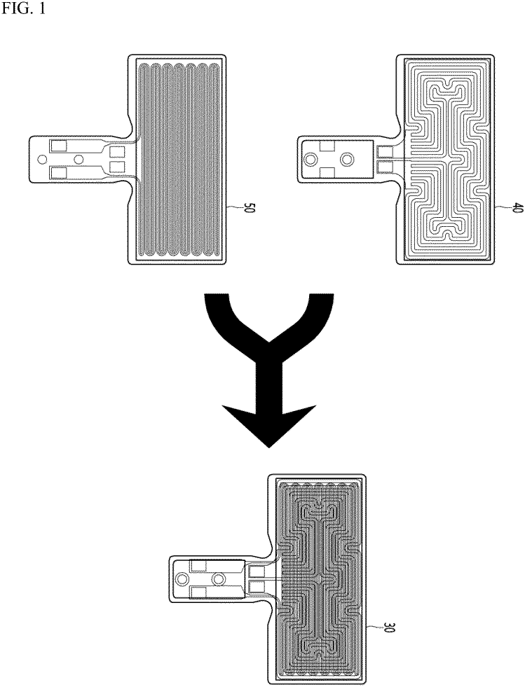

According to some embodiments of the present disclosure, a film-type heater including a first electroconductive pattern (hereinafter referred to as “heating pattern”) configured to perform a heating function and a second electroconductive pattern (hereinafter referred to as “sensor pattern”) configured to perform a temperature measurement function may be provided. More specifically, as illustrated in FIG. 1, a film-type heater 30 in which a heating pattern 40 and a sensor pattern 50 are integrated may be provided. However, the scope of the present disclosure is not limited thereto, and the technical spirit incorporated in this embodiment may also be applied to heaters other than a film-type heater. In the film-type heater 30 illustrated in FIG. 1, the sensor pattern may directly measure a temperature of a heating surface on which the heating pattern is disposed and thus may minimize a measurement error. When such a heater 30 is applied to an aerosol generation device, temperature control of the heater may be very precisely performed. Hereinafter, to provide convenience in understanding, description will continue assuming that the film-type heater 30 is for use in an aerosol generation device. However, this does not mean that the film-type heater 30 according to the embodiments is limited to being used for an aerosol generation device.

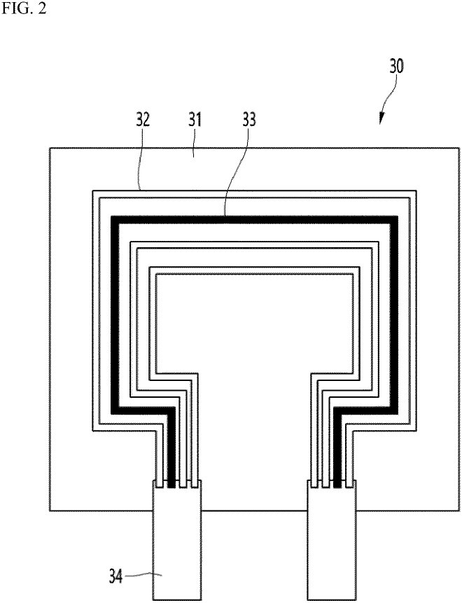

Hereinafter, the film-type heater 30 according to the embodiments described above will be described in detail with reference to FIG. 2 and so on.

FIG. 2 is an exemplary view for describing the film-type heater 30 according to some embodiments of the present disclosure.

As illustrated in FIG. 2, the film-type heater 30 may include a base film 31, a heating pattern 32, a sensor pattern 33, and a terminal 34. However, only the components relating to the embodiment of the present disclosure are illustrated in FIG. 2. Therefore, those of ordinary skill in the art to which the present disclosure pertains should understand that the film-type heater 30 may further include general-purpose components other than the components illustrated in FIG. 2. Hereinafter, each component of the film-type heater 30 will be described, and for convenience of description, the film-type heater 30 will be shortened to “heater 30.”

The base film 31 may be a heat-resistant or insulating film that constitutes a base of the heater 10. For example, a heat-resistant or insulating film such as a polyimide (hereinafter, “PI”) film may be used as the base film 31. One or more electroconductive patterns 32 and 33 may be formed on the base film 31. Here, the electroconductive patterns 32 and 33 may be formed using various methods such as printing and applying. Therefore, the scope of the present disclosure is not limited to a specific pattern forming method.

Although not illustrated, the heater 30 may further include, in addition to the base film 31, a cover film (not illustrated) configured to cover an upper surface of the heater 30. The cover film (not illustrated) may also be formed of a heat-resistant or insulating film such as a PI film.

Next, the heating pattern 32 may perform a heating function as power (or a voltage) is applied thereto through the terminal 34. In other words, the heating pattern 32 may be made of an electroconductive material and generate heat as power is applied thereto, thus heating an object (e.g., an aerosol-generating article).

The heating pattern 32 may be made of various types of electroconductive materials, but preferably, the heating pattern 32 may be made of a material with a low temperature coefficient of resistance (hereinafter, “TCR”). This is because, with a material with a low TCR, an increase in a resistance value when a temperature rise occurs is insignificant and the amount of current hardly decreases, and thus a temperature may rise quickly. When the heater 30 including such a heating pattern 32 is applied to an aerosol generation device, due to a high-speed temperature rise, the preheating time of the device may be reduced and a tobacco smoke taste at the beginning of smoking can be significantly enhanced.

Examples of a material with a low TCR include constantan, manganin, nickel silver, etc. However, the scope of the present disclosure is not limited thereto. The TCRs of electroconductive materials such as constantan, copper, and aluminum are shown in Table 1 below.

TABLE 1

| Classification | Copper | Aluminum | SUS304 | Constantan |
|---|---|---|---|---|
| TCR (ppm/°C) | 3900 | 3900 | 2000 | 8 |

In some embodiments, an electroconductive material with a TCR of about 1,500 ppm/°C or lower may be used for a heating heater. Preferably, a material with a TCR lower than or equal to about 1,000 ppm/°C, 700 ppm/°C, 500 ppm/°C, 300 ppm/°C, or 100 ppm/°C may be used. More preferably, a material with a TCR lower than or equal to about 50 ppm/°C, 30 ppm/°C, or 20 ppm/°C may be used. In this case, a high-speed temperature rise of the heater may be guaranteed more reliably.

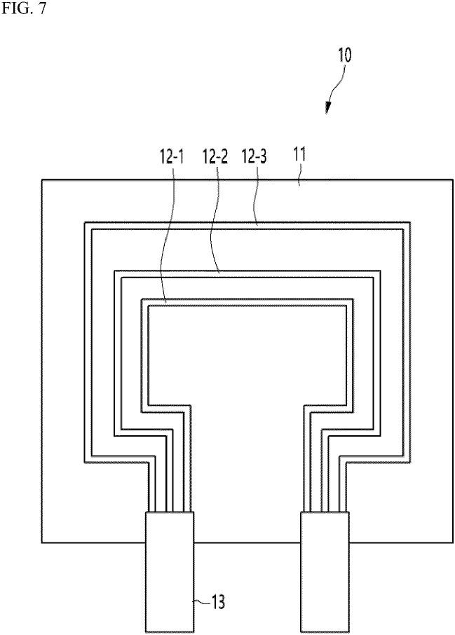

Meanwhile, FIG. 2 illustrates an example in which a plurality of heating patterns 32 are disposed in a parallel structure, but the scope of the present disclosure is not limited thereto. The structure of the heating pattern 32 will be described in detail below with reference to FIG. 7 and so on.

Next, the sensor pattern 33 may measure a temperature of the heating pattern 32. Temperature measurement may be performed on the basis of a TCR of the sensor pattern 33. Since a method of temperature measurement using a TCR should already be sufficiently familiar to those of ordinary skill in the art, description thereof will be omitted.

Preferably, the sensor pattern 33 may be made of a material with a high TCR, unlike the heating pattern 32. This is because the resistance value of a material having a high TCR is sensitive to temperature, which means that temperature measurement may be performed more precisely. Examples of a material with a high TCR include copper, aluminum, etc., but the scope of the present disclosure is not limited thereto.

In some embodiments, the sensor pattern 33 may be made of a material whose TCR is higher than that of the heating pattern 32. For example, in a case in which the heating pattern 32 is made of a material such as constantan, the sensor pattern 33 may be made of a copper material. In this way, a heating temperature of the heating pattern 32 may be accurately measured through the sensor pattern 33.

Meanwhile, the number of sensor patterns 33, a position at which the sensor pattern 33 is disposed, etc. may be designed in various ways.

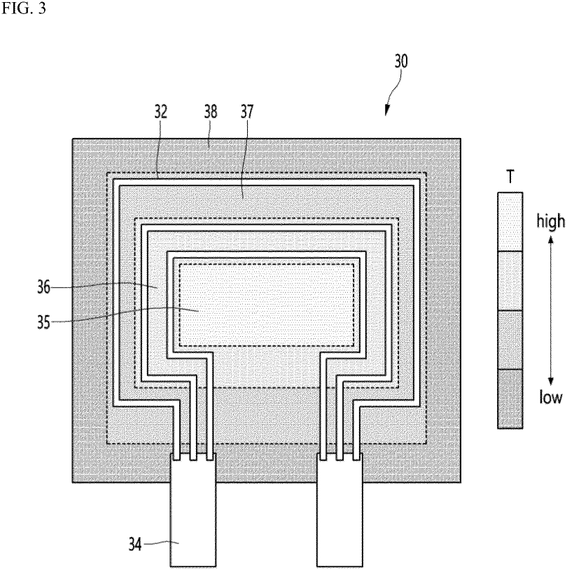

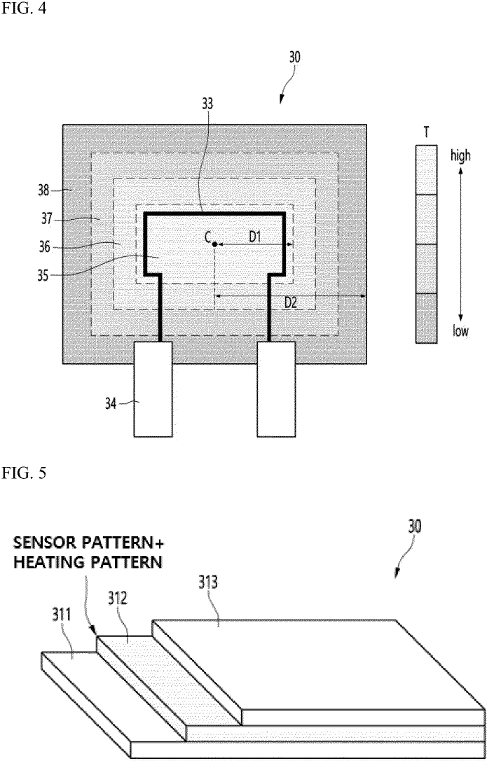

In some embodiments, the sensor pattern 33 may be disposed to measure (i.e., sense) a temperature of a central region of a heating surface (that is, a surface on which the heating pattern 32 is disposed) of the heater 30. In this way, control precision of the heater 30 may be improved. Hereinafter, to provide convenience of understanding, this embodiment will be further described with reference to FIGS. 3 and 4.

In the case of a film-type heater, heating (i.e., an amount of heat) is concentrated on the center of a heating surface oftentimes. For example, as illustrated in FIG. 3, in a case in which a plurality of heating patterns 32 are disposed in a parallel structure, a central region 35 of the heating surface of the heater 30 may be heated at the highest temperature and the heating temperature may progressively decrease toward periphery regions 36, 37, and 38. An outer heating pattern has a length larger than a length of a central heating pattern and thus has a resistance value higher than a resistance value of the central heating pattern. This may be understood as a reason for the above phenomenon.

When the above concentrated heating phenomenon occurs, controlling the heater 30 on the basis of a temperature of the central region 35, rather than on the basis of temperatures of the edge regions 36 to 38, may be suitable for improving control precision. This is because the central region 35 has the highest heating value and thus has the greatest influence on an object to be heated (e.g., an aerosol-generating article). Therefore, preferably, the sensor pattern 33 may be disposed to measure (i.e., sense) the temperature of the central region (e.g., 35) of the heating surface of the heater 30. For example, as illustrated in FIG. 4, at least a portion of the sensor pattern 33 may be disposed in the central region 35.

In the previous embodiments, a distance D1 from a center C of the heating surface of the heater 30 to an edge of the central region 35 may be about 0.15 to 0.5 times, preferably, about 0.2 to 0.5 times, about 0.15 to 0.4 times, about 0.2 to 0.4 times, or about 0.2 to 0.3 times, a distance D2 from the center C to an edge of the heating surface. Generally, heating is concentrated on the region 35 formed within such numerical ranges, and thus the sensor pattern 33 being disposed in the corresponding region 35 may be effective in improving the control precision for the heater 30.

The heating pattern 32 and the sensor pattern 33 may be implemented in various specific ways.

In some embodiments, the sensor pattern 33 may be manufactured to have a resistance value higher than a resistance value of the heating pattern 32. For example, a resistance value of the sensor pattern 33 may be higher than a resistance value of the heating pattern 32 by a factor of about 5, 6, 7, or 10. Such a difference in resistance may be achieved by manufacturing the sensor pattern 33 using a material with high resistivity or manufacturing the sensor pattern 33 with a small thickness or large length. In such cases, since current hardly flows in the sensor pattern 33 when power is applied to the heater 30, the sensor pattern 33 may accurately perform only the temperature measurement function.

In some other embodiments, the sensor pattern 33 may have a resistance value equal or similar to a resistance value of the heating pattern 32, and in this case, power (or a voltage) applied to the sensor pattern 33 may be extremely lower than power (or a voltage) applied to the heating pattern 32. For example, in a case in which the sensor pattern 33 is configured to be connected to a first terminal and the heating pattern 32 is configured to be connected to a second terminal, by a controller (not illustrated) applying relatively low power to the first terminal, the pattern 33 may serve as a sensor pattern. In this case, by controlling the power applied to each terminal, the controller (not illustrated) may operate a specific pattern 32 as a sensor pattern or a heating pattern. In another example, the power applied to the sensor pattern 33 may be configured to be reduced in terms of circuitry through a circuit element that causes a voltage drop.

Meanwhile, although the heating pattern 32 and the sensor pattern 33 are both illustrated as being disposed on the base film 31 (that is, on the same layer) in FIG. 2 and so on, the sensor pattern 33 and the heating pattern 32 may be disposed on different layers, and this may vary according to embodiments.

In some embodiments, as illustrated in FIG. 5, the heating pattern 32 and the sensor pattern 33 may be disposed on the same layer. Specifically, the heater 30 may consist of a first layer 311, a second layer 312, and a third layer 313, and the heating pattern 32 and the sensor pattern 33 may be disposed together on the second layer 312. Here, the base film 31 may be disposed on the first layer 311, and the cover film (not illustrated) may be disposed on the third layer 313. Also, although not illustrated, an adhesive film may be disposed between the layers 311 to 333. According to this embodiment, since the sensor pattern 33 and the heating pattern 32 are disposed on the same layer, a temperature measurement error may be further minimized.

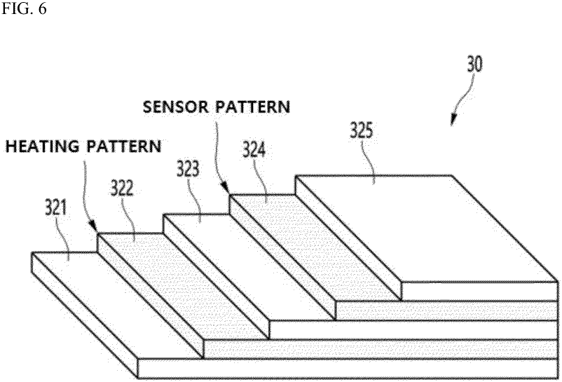

In some other embodiments, as illustrated in FIG. 6, the heating pattern 32 and the sensor pattern 33 may be disposed on different layers. Specifically, the heater 30 may consist of a first layer 321, a second layer 322, a third layer 323, a fourth layer 324, and a fifth layer 325, and the heating pattern 32 may be disposed on the second layer 322 while the sensor pattern 33 is disposed on the fourth layer 324. Here, the base film 31 may be disposed on the first layer 321, the cover film (not illustrated) may be disposed on the fifth layer 325, and an insulating film (e.g., a PI film) may be disposed on the third layer 323 to prevent a short circuit between the patterns 32 and 33. Also, although not illustrated, an adhesive film may be disposed between the layers 321 to 325. According to this embodiment, a temperature measurement error may increase as compared to the previous embodiment. However, since the electroconductive patterns 32 and 33 are disposed on different layers, the manufacturing process may be significantly simplified, and a problem of interference between the electroconductive patterns may be significantly mitigated.

Description will be given by referring back to FIG. 2.

Next, the terminal 34 may be a circuit element for applying power (or a voltage) to one or more electroconductive patterns 32 and 33. Since configurations and functions of the terminal 34 should be sufficiently familiar to those of ordinary skill in the art, description thereof will be omitted.

The film-type heater 30 according to some embodiments of the present disclosure has been described above with reference to FIGS. 2 to 6. According to the above description, the heater 30 may be manufactured in a form in which the heating pattern 32 and the sensor pattern 33 are integrated. In this case, since the temperature of the heating surface on which the heating pattern 32 is disposed may be directly measured through the sensor pattern 33, a temperature measurement error of the heater 30 may be minimized. Also, accordingly, control precision for the heater 30 may be improved, and a more improved smoking experience may be provided to the user. Further, since there is no need to perform the process of assembling (attaching) a separate temperature sensor when manufacturing an aerosol generation device, the process of manufacturing the aerosol generation device may also be simplified.

Hereinafter, a heating pattern structure of a film-type heater will be described in detail with reference to FIGS. 7 to 10. However, for clarity of the present disclosure, description of content overlapping with the previous embodiments will be omitted.

FIG. 7 is an exemplary view for describing a heating pattern structure of a film-type heater 10 according to a first embodiment of the present disclosure. In FIG. 7 and so on, a sensor pattern (e.g., 33) is omitted for convenience of understanding.

As illustrated in FIG. 7, the heater 10 may include a base film 11, a plurality of heating patterns 12-1, 12-2, and 12-3, and a terminal 13. Hereinafter, the reference numeral “12” will be used when referring to an arbitrary heating pattern 12-1, 12-2, or 12-3 or collectively referring to the plurality of heating patterns 12-1 to 12-3.

As illustrated, the heater 10 according to this embodiment may include the plurality of heating patterns 12 disposed (i.e., formed) in a parallel structure. Through the parallel arrangement structure, even when a material with high resistivity is used, a target resistance value of the heater 10 may be satisfied. FIG. 7 illustrates an example in which three heating patterns 12-1 to 12-3 are disposed in a parallel structure, but the number of heating patterns 12 may vary. For example, the number of heating patterns 12 may be determined on the basis of a heating area of the heater 10 and target resistance (that is, target resistance of the entire heater 10). More specifically, when the target resistance is the same, the number of heating patterns 12 may increase with a decrease in the heating area. This is because the length of the heating pattern 12 should be decreased to satisfy the same target resistance value within a narrow area.

For reference, the number and/or arrangement structure of the heating patterns 12 are related to the heating area and target resistance of the heater 10 but may also be closely related to resistivity of a material. This is because a material with high resistivity increases resistance of the heating patterns 12 and thus inevitably increases the overall resistance of the heater 10. Therefore, in a case in which the heating patterns 12 are made of a material with high resistivity, it may be preferable to arrange the plurality of heating patterns 12 in a parallel structure in order to satisfy target resistance. For example, since constantan has higher resistivity than copper or the like despite its low TCR, in a case in which constantan is used as a material of the heating patterns 12, it may be preferable to arrange the plurality of heating patterns 12 in a parallel structure in order to decrease the overall resistance.

In some embodiments, at least one of the plurality of heating patterns 12 disposed in a parallel structure may be made of a material whose resistivity is higher than or equal to about 1.0×10⁻⁸ Ωm, 3.0×10⁻⁸ Ωm, 5.0×10⁻⁸ Ωm, or 7.0×10⁻⁸ Ωm. Even when materials having such resistivity values are used, a target resistance value for the heating performance to be sufficiently exhibited may be satisfied through the parallel structure.

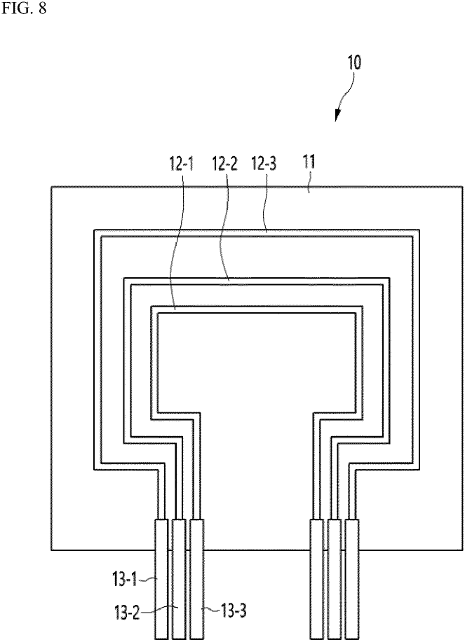

Next, the terminal 13 may be designed to collectively apply power to the plurality of heating patterns 12 or may be designed to independently apply power to each heating pattern 12. For example, as illustrated in FIG. 8, each of a plurality of terminals 13-1, 13-2, and 13-3 may be connected to one of the heating patterns 12-1 to 12-3 to independently apply power thereto. In this case, since the operation of a first heating pattern 12-1 may be independently controlled through a first terminal 13-1 and the operation of a second heating pattern 12-2 may be independently controlled through a second terminal 13-3, control precision for the heater 10 may be further improved. Such a control method will be described in detail below with reference to FIG. 14.

The heating pattern structure of the heater 10 according to the first embodiment of the present disclosure has been described above with reference to FIGS. 7 and 8. According to the above description, even when the heating patterns 12 are made of a material with high resistivity, the target resistance value of the heater 10 may be satisfied through the parallel structure. Also, since most materials with a low TCR have high resistivity, the target resistance value of the heater 10 may be sufficiently satisfied even when the heating patterns 12 are made of materials with a low TCR. That is, through the above-described parallel arrangement structure, the film-type heater 10 including heating patterns made of a material with a low TCR may be easily manufactured. The heater 10 may guarantee a high-speed temperature rise and thus decrease the preheating time of an aerosol generation device and significantly enhance a tobacco smoke taste at the beginning of smoking. The temperature rise speed of the heater 10 will be further described below by referring to Experimental Example 1.

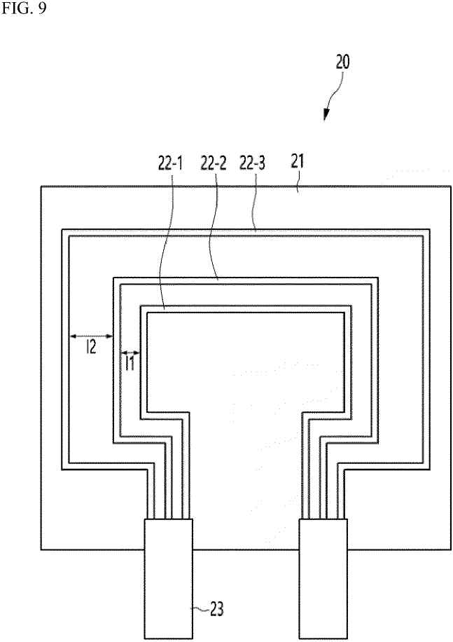

Hereinafter, a heating pattern structure of a heater 20 according to a second embodiment of the present disclosure will be described with reference to FIGS. 9 and 10. The second embodiment relates to a heating pattern structure capable of mitigating a concentrated heating phenomenon and guaranteeing a uniform heat distribution.

FIG. 9 is an exemplary view for describing the heater 20 according to the second embodiment of the present disclosure.

As illustrated in FIG. 9, the heater 20 according to this embodiment may also include a base film 21, a plurality of heating patterns 22-1, 22-2, and 22-3, and a terminal 23. However, in order to guarantee a uniform heat distribution, an outer heating pattern (e.g., 22-3) may be designed to have a resistance value lower than or equal to a resistance value of a central heating pattern (e.g., 22-1). In this way, a phenomenon in which heating is concentrated on a central region thereof may be mitigated.

The resistance values of the outer heating pattern (e.g., 22-3) and the central heating pattern (e.g., 22-1) may be implemented using various methods, and the methods may vary according to embodiments.

In some embodiments, resistance values may be implemented through a difference in intervals between heating patterns. For example, as illustrated, the plurality of heating patterns 22-1 to 22-3 may be disposed such that an interval 12 between a third heating pattern 22-3 and a second heating pattern 22-2 is larger than an interval 11 between the second heating pattern 22-2 and a first heating pattern 22-1. In this case, as areas of the heating patterns (e.g., 22-3 and 22-2) disposed at the periphery increase, the resistance values of the heating patterns (e.g., 22-3 and 22-2) may decrease. That is, although the lengths of the outer heating patterns (e.g., 22-3 and 22-2) increase, the resistance values thereof may decrease because the area of the outer heating patterns increase. Accordingly, the resistance values may be implemented such that the resistance value of the outer heating pattern (e.g., 22-3) is not higher than the resistance value of the central heating pattern (e.g., 22-1).

In some embodiments, resistance values may be implemented through a difference in materials of heating patterns. Specifically, a second heating pattern (e.g., 22-3) disposed outside a first heating pattern (e.g., 22-1) may be made of a material whose resistivity is lower than resistivity of a material of the first heating pattern (e.g., 22-1). For example, the first heating pattern may be made of constantan, and the second heating pattern may be made of copper. Even in this case, the resistance values may be implemented such that the resistance value of the outer heating pattern (e.g., 22-3) is not higher than the resistance value of the central heating pattern (e.g., 22-1).

In some embodiments, resistance values may be implemented through a difference in thicknesses of heating patterns. For example, as illustrated in FIG. 10, a thickness T2 of a second heating pattern 22-3 disposed outside a first heating pattern 22-2 may be thicker than a thickness T1 of the first heating pattern 22-2. As a result, the resistance values may be implemented such that the resistance value of the outer heating pattern (e.g., 22-3) is not higher than the resistance value of the central heating pattern (e.g., 22-2) due to the larger thickness of the outer heating pattern.

However, when the thickness of the heating pattern (e.g., 22-3) is too thick, the flexibility of the heater 20 may decrease, and the heater 20 may lose its functionality as a film-type heater 20. Thus, there is a need to process the heating pattern (e.g., 22-3) to have a suitable thickness (e.g., T2). In some embodiments, the thickness (e.g., T2) of the heating pattern (e.g., 22-3) may be less than or equal to about 150 µm, preferably, less than or equal to about 130 µm, 120 µm, 110 µm, or 100 µm, and more preferably, less than or equal to about 90 µm, 70 µm, 50 µm, 30 µm, or 10 µm. The flexibility of the film-type heater 20 may be guaranteed within such numerical ranges. Also, the thickness (e.g., T2) of the heating pattern (e.g., 22-3) may be larger than or equal to about 5 µm or 10 µm. This may be understood to be for preventing an increase in the level of difficulty of a heating pattern forming process and a sharp increase in the resistance value.

The heater 20 according to the second embodiment of the present disclosure has been described above with reference to FIGS. 9 and 10. According to the above description, the plurality of heating patterns 22-1 to 22-3 may be disposed in a parallel structure, and the resistance value of the outer heating pattern (e.g., 22-3) may be designed to not be higher than the resistance value of the central heating pattern (e.g., 22-1). Accordingly, heating may be uniformly performed throughout the entire heating surface of the heater 20. The heat distribution of the heater 20 will be further described below by referring to Experimental Example 2.

Hereinafter, various types of aerosol generation devices 100-1, 100-2, and 100-3 to which the film-type heaters 10, 20, and 30 according to the embodiments may be applied will be described with reference to FIGS. 11 to 13.

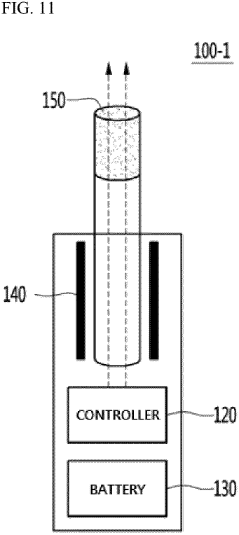

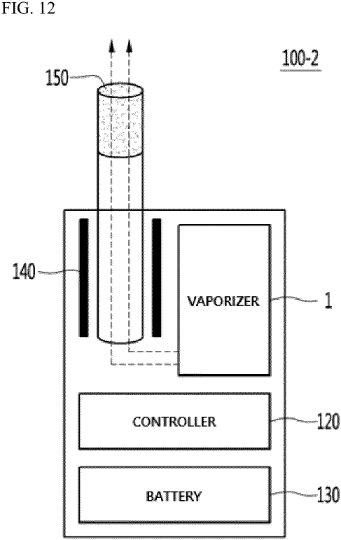

FIGS. 11 to 13 are exemplary block diagrams illustrating the aerosol generation devices 100-1 to 100-3. Specifically, FIG. 11 illustrates a cigarette-type aerosol generation device 100-1, and FIGS. 12 and 13 illustrate hybrid-type aerosol generation devices 100-2 and 100-3 in which a liquid and a cigarette are used together. Hereinafter, each of the aerosol generation devices 100-1 to 100-3 will be described.

As illustrated in FIG. 11, the aerosol generation device 100-1 may include a heater 140, a battery 130, and a controller 120. However, this is only a preferred embodiment for achieving the objectives of the present disclosure, and, of course, some components may be added or omitted as necessary. Also, the components of the aerosol generation device 100-1 illustrated in FIG. 11 represent functional components that are functionally distinct, and the plurality of components may be implemented in a form in which they are integrated with each other in an actual physical environment, or a single component may be implemented in a form in which it is divided into a plurality of specific functional components. Hereinafter, each component of the aerosol generation device 100-1 will be described.

The heater 140 may be disposed to heat a cigarette 150 inserted thereinto. The cigarette 150 may include a solid aerosol-forming substrate and generate an aerosol when heated. The generated aerosol may be inhaled by a user through the oral region of the user. The operation, heating temperature, etc. of the heater 140 may be controlled by the controller 120.

The heater 140 may be implemented as the above-described heater 10, 20, or 30. In this case, through a high-speed temperature rise, a preheating time of the aerosol generation device 100-1 may be decreased, and a tobacco smoke taste at the beginning of smoking may be enhanced. Also, since a temperature measurement error is significantly reduced, control precision for the heater 140 may be improved.

Next, the battery 130 may supply power used to operate the aerosol generation device 100-1. For example, the battery 130 may supply power to allow the heater 140 to heat the aerosol-forming substrate included in the cigarette 150 and may supply power required for the operation of the controller 120.

Also, the battery 130 may supply power required to operate electrical components such as a display (not illustrated), a sensor (not illustrated), and a motor (not illustrated) which are installed in the aerosol generation device 100-1.

Next, the controller 120 may control the overall operation of the aerosol generation device 100-1. For example, the controller 120 may control the operation of the heater 140 and the battery 130 and may also control the operation of other components included in the aerosol generation device 100-1. The controller 120 may control the power supplied by the battery 130, the heating temperature of the heater 140, and the like. Also, the controller 120 may check a state of each of the components of the aerosol generation device 100-1 and determine whether the aerosol generation device 100-1 is in an operable state.

In some embodiments, the controller 120 may dynamically control the operation of a plurality of electroconductive patterns constituting the heater 140 according to predetermined conditions. This embodiment will be described in detail below with reference to FIG. 14.

The controller 120 may be implemented with at least one processor. The processor may also be implemented with an array of a plurality of logic gates or implemented with a combination of a general-purpose microprocessor and a memory which stores a program that may be executed by the microprocessor. Also, those of ordinary skill in the art to which the present disclosure pertains should clearly understand that the controller 120 may also be implemented with other forms of hardware.

Hereinafter, the hybrid-type aerosol generation devices 100-2 and 100-3 will be briefly described with reference to FIGS. 12 and 13.

FIG. 12 illustrates the aerosol generation device 100-2 in which a vaporizer 1 and the cigarette 150 are disposed in parallel, and FIG. 13 illustrates the aerosol generation device 100-3 in which the vaporizer 1 and the cigarette 150 are disposed in series. However, an internal structure of an aerosol generation device is not limited to those illustrated in FIGS. 12 and 13, and the arrangement of components may be changed according to a design method.

In FIGS. 12 and 13, the vaporizer 1 may include a liquid reservoir configured to store a liquid aerosol-forming substrate, a wick configured to absorb the aerosol-forming substrate, and a vaporizing element configured to vaporize the absorbed aerosol-forming substrate to generate an aerosol. The vaporizing element may be implemented in various forms such as a heating element or a vibration element. Also, in some embodiments, the vaporizer 1 may be designed to have a structure that does not include the wick. The aerosol generated in the vaporizer 1 may pass through the cigarette 150 and be inhaled through the oral region of the user. The vaporizing element of the vaporizer 1 may also be controlled by the controller 120.

The exemplary aerosol generation devices 100-1 to 100-3, to which the heaters 10, 20, and 30 according to some embodiments of the present disclosure may be applied, have been described above with reference to FIGS. 11 to 13. Hereinafter, a control method of a film-type heater for aerosol generation devices according to some embodiments of the present disclosure will be described with reference to FIG. 14.

Hereinafter, in describing the control method, it is assumed that the film-type heater (e.g., 10, 20, or 30) includes a plurality of patterns including a first electroconductive pattern and a second electroconductive pattern and the function, operation, and/or heating temperature of each pattern may be independently controlled. Also, the control method may be implemented using one or more instructions executed by the controller 120 or a processor, and when the subject of a specific operation is omitted, the specific operation may be understood as being performed by the controller 120. Hereinafter, for convenience of description, “electroconductive pattern” will be shortened to “pattern.”

FIG. 14 is an exemplary flowchart schematically illustrating a control method of a film-type heater according to some embodiments of the present disclosure.

As illustrated in FIG. 14, the control method may begin by monitoring a smoking state (S10). Here, the smoking state may include all kinds of state information that may be measured during smoking, such as a smoking stage, a puff state, and a heater temperature.

In steps S20 and S30, in response to determination that a first condition is satisfied, both a first pattern and a second pattern may be operated as a heating pattern. For example, the controller 120 may apply sufficient power to the first pattern and the second pattern and control each pattern to perform a heating function.

The first condition may be defined and set in various ways. For example, the first condition may indicate a preheating time (e.g., first five seconds, etc.). In this case, as a plurality of patterns operate as heating patterns during the preheating time, a temperature rise may occur at a high speed. As another example, the first condition may be defined on the basis of a puff state (e.g., a puff interval, a puff intensity). For example, the first condition may be satisfied when a puff interval is less than or equal to a reference value or a puff intensity is higher than or equal to a reference value. In this case, as the puff interval decreases or the puff intensity increases, the plurality of patterns may operate as heating patterns, and thus a stronger tobacco smoke taste may be provided to the user. In addition, the first condition may be defined on the basis of various other elements such as a smoking time, a puff number, and a heating temperature of a heater.

In some embodiments, control may be performed to control the number of heating patterns (that is, the number of patterns that operate as heating patterns) among the plurality of patterns. For example, the controller 120 may increase or decrease the number of heating patterns according to a puff state (e.g., a puff interval, a puff intensity) (for example, increase the number when the puff intensity is higher than or equal to a reference value and decrease the number when the puff intensity is lower than the reference value). As another example, the controller 120 may increase or decrease the number of heating patterns according to a smoking stage (for example, increase the number at the beginning of smoking, decrease the number in the middle of smoking, and increase the number again towards the end of smoking to enhance a tobacco smoke taste). As still another example, the controller 120 may increase or decrease the number of heating patterns according to a heating temperature of a heater to perform feedback control.

In steps S40 and S50, in response to determination that a second condition is satisfied, a specific pattern may be operated as a sensor pattern. For example, the controller 120 may reduce the power applied to the first pattern to prevent the first pattern from generating heat and may measure the temperature of the heater on the basis of a change in the TCR and resistance value of the first pattern.

The second condition may be set in various ways. For example, the second condition may indicate an elapse of preheating time. In this case, after preheating is completed, feedback control may be performed according to a result of measuring the temperature of the heater. As another example, the second condition may be defined on the basis of a puff state (e.g., a puff interval, a puff intensity). For example, the second condition may be satisfied when a puff interval is larger than or equal to a reference value or a puff intensity is less than or equal to a reference value. In this case, as the puff interval increases or the puff intensity decreases, feedback control may be performed according to a result of temperature measurement by the sensor pattern.

In some embodiments, heat distribution of a heating surface of a heater may be measured using a plurality of sensor patterns. For example, the controller 120 may compare results of temperature measurement by a central sensor pattern and an outer sensor pattern to determine uniformity of heat distribution. Also, in a case in which heating is concentrated on the central region, the controller 120 may perform control by supplying more power to an outer heating pattern or supplying less power to a central heating pattern. According to such control, heating may be uniformly performed throughout the entire heating surface of the heater.

Meanwhile, although FIG. 14 illustrates that step S40 is performed in a case in which the first condition is not satisfied, this is only an example for providing convenience of understanding, and steps S20 and S40 may be performed independently of each other.

The control method of the heater for aerosol generation devices according to some embodiments of the present disclosure has been described above with reference to FIG. 14. According to the above-described method, by dynamically controlling functions, operations, and the like of a plurality of patterns according to predetermined conditions, the heater may be efficiently utilized during smoking.

The technical spirit of the present disclosure described above with reference to FIG. 14 may be implemented with computer-readable code on computer-readable recording media. Examples of the computer-readable recording media may include removable recording media (a compact disc (CD), a digital versatile disc (DVD), a Blu-Ray disk, a Universal Serial Bus (USB) storage device, or a removable hard disk) or non-removable recording media (a read-only memory (ROM), a random access memory (RAM), or a built-in hard disk). Computer programs recorded in the computer-readable recording media may be sent to other computing devices through a network, such as the Internet, and installed on the other computing devices to be used in the other computing devices.

Hereinafter, the configurations and effects of the above-described heaters 10, 20, and 30 will be described in more detail using examples and a comparative example. However, the following examples are only some examples of the heaters 10, 20, and 30 described above, and thus the scope of the present disclosure is not limited by the following examples.

### Embodiment 1

A heater having patterns made of constantan disposed in parallel was manufactured. Specifically, the patterns were disposed in a three-row parallel structure as illustrated in FIG. 7, intervals between the patterns were designed to be uniform and designed be 0.5 mm, and thicknesses of the patterns were also designed to be uniform and designed to be 20 µm. Also, a PI film was used as a base film of the heater.

### Comparative Example 1

A heater was manufactured in the same manner as in Embodiment 1 except that patterns made of copper were disposed in series.

### Experimental Example 1: Comparison of Temperature Rise Speed

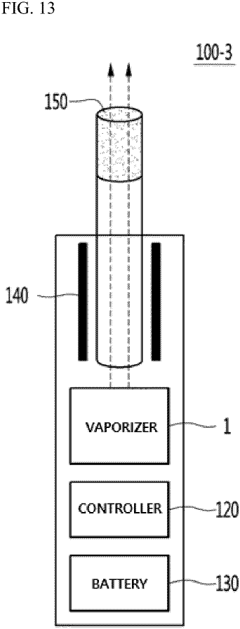

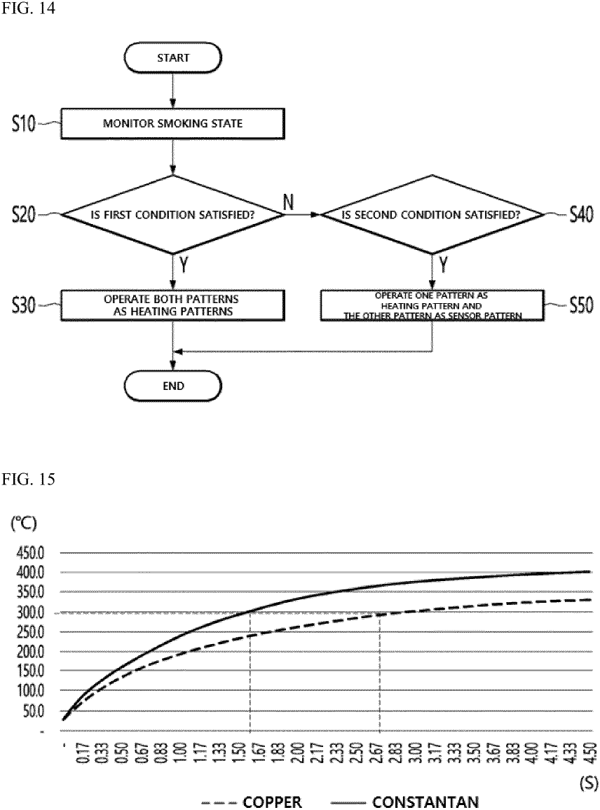

An experiment was conducted to compare temperature rise speeds of the heaters according to Embodiment 1 and Comparative Example 1. Specifically, an experiment for measuring a change in temperature of the heater over time was conducted, and experimental results are shown in FIG. 15.

Referring to FIG. 15, it can be seen that the temperature rise speed of the heater according to Embodiment 1 is much faster than the temperature rise speed of the heater according to Comparative Example 1. For example, when it is assumed that a target temperature is 300° C., it can be seen that, while it takes only about 1.6 seconds for the heater according to Embodiment 1 to reach the target temperature, the heater according to Comparative Example 1 reaches the target temperature after about 2.7 seconds. This is determined to be due to constantan having a low TCR, which causes the resistance value to hardly increase at the time of temperature rise and causes the current flowing in the patterns to hardly decrease at the time of temperature rise. According to such experimental results, it can be seen that the heater (e.g., 10) according to the embodiments described above may decrease the preheating time of the aerosol generation devices (e.g., 100-1 to 100-3) and enhance a tobacco smoke taste at the beginning of smoking.

### Embodiments 2 and 3

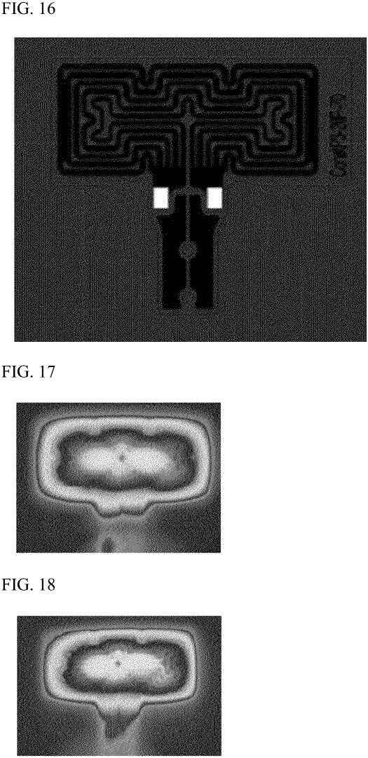

As illustrated in FIG. 16, heaters according to Embodiments 2 and 3 were manufactured by arranging patterns made of constantan in five parallel rows. The patterns of the heater according to Embodiment 2 were arranged in intervals progressively increasing toward the periphery, and the patterns of the heater according to Embodiment 3 were arranged in almost equal intervals. Tables 2 and 3 below may be referenced for specific numerical values of the thicknesses, lengths, and intervals of the patterns. Table 2 relates to Embodiment 2, and Table 3 relates to Embodiment 3.

TABLE 2

| Classification | First row (outermost) | Second row | Third row | Fourth row | Fifth row (central) |
|---|---|---|---|---|---|
| Thickness (µm) | 20 | 20 | 20 | 20 | 20 |
| Length (mm) | 70.97 | 69.51 | 66.51 | 66.42 | 63.42 |
| Interval (mm) | 0.55 | 0.5 | 0.45 | 0.42 | 0.4 |

TABLE 3

| Classification | First row (outermost) | Second row | Third row | Fourth row | Fifth row (central) |
|---|---|---|---|---|---|
| Thickness (µm) | 20 | 20 | 20 | 20 | 20 |
| Length (mm) | 70.97 | 69.51 | 66.51 | 66.42 | 63.42 |
| Interval (mm) | 0.49 | 0.47 | 0.45 | 0.45 | 0.43 |

### Experimental Example 2: Comparison of Heat Distribution

An experiment was conducted to measure heat distribution of heating surfaces of the heaters according to Embodiments 2 and 3, and experimental results relating thereto are illustrated in FIGS. 17 and 18. FIGS. 17 and 18 illustrate the heating surfaces of the heaters according to Embodiments 2 and 3 in the form of heat maps.

Comparing FIGS. 17 and 18, it can be seen that a concentrated heating region (see the central region) of FIG. 18 is formed in a smaller size as compared to FIG. 17. This indicates that the concentrated heating phenomenon occurs more strongly in the heater according to Embodiment 3. Also, it may be understood that, by designing the intervals between the patterns to progressively increase toward the periphery, the resistance value of the outer pattern may be decreased, and ultimately, the concentrated heating phenomenon may be mitigated.

The configurations and effects of the above-described heaters 10, 20, and 30 have been described in more detail above using the examples and the comparative example.

The embodiments of the present disclosure have been described above with reference to the accompanying drawings, but those of ordinary skill in the art to which the present disclosure pertains should understand that the present disclosure may be embodied in other specific forms without changing the technical spirit or essential features thereof. Therefore, the embodiments described above should be understood as being illustrative, instead of limiting, in all aspects. The scope of the present disclosure should be interpreted based on the claims below, and any technical spirit within the scope equivalent to the claims should be interpreted as falling within the scope of the technical spirit defined by the present disclosure.

What is claimed is:

1. A heater comprising:
a first electroconductive pattern which is configured to perform a heating function; and
a second electroconductive pattern which is made of a material having a higher temperature coefficient of resistance than the first electroconductive pattern and is configured to perform a temperature measurement function for the heater.

2. The heater of claim 1, wherein the first electroconductive pattern and the second electroconductive pattern are disposed on a same layer.

3. The heater of claim 1, wherein the first electroconductive pattern and the second electroconductive pattern are disposed on different layers.

4. The heater of claim 1, wherein the second electroconductive pattern has a higher resistance value than the first electroconductive pattern.

5. The heater of claim 1, wherein power supplied to the second electroconductive pattern is smaller than power supplied to the first electroconductive pattern.

6. The heater of claim 1, wherein:
the second electroconductive pattern is disposed to measure a temperature of a central region of a heating surface on which the first electroconductive pattern is disposed; and
a distance from a center of the heating surface to an edge of the central region is 0.15 to 0.5 times a distance from the center to an edge of the heating surface.

7. The heater of claim 1, further comprising a third electroconductive pattern which is disposed in a parallel structure with the first electroconductive pattern and configured to perform the heating function,
wherein the first electroconductive pattern is made of a material whose temperature coefficient of resistance is 1,000 ppm/°C or lower.

8. The heater of claim 7, wherein the first electroconductive pattern is made of a material whose resistivity is higher than or equal to 3.0× 10⁻⁸ Ωm.

9. The heater of claim 7, wherein:
the third electroconductive pattern is disposed outside the first electroconductive pattern; and
a resistance value of the third electroconductive pattern is less than or equal to a resistance value of the first electroconductive pattern.

10. The heater of claim 7, wherein:
the third electroconductive pattern is disposed outside the first electroconductive pattern;
the heater further comprises a fourth electroconductive pattern which is disposed outside the third electroconductive pattern; and
an interval between the fourth electroconductive pattern and the third electroconductive pattern is larger than an interval between the third electroconductive pattern and the first electroconductive pattern.

11. The heater of claim 7, wherein:
the third electroconductive pattern is disposed outside the first electroconductive pattern;
a thickness of the third electroconductive pattern is thicker than a thickness of the first electroconductive pattern; and
the thickness of the third electroconductive pattern is less than or equal to 100 µm.

12. The heater of claim 1, wherein the first electroconductive pattern is made of at least one material of constantan, manganin, and nickel silver.
